(19) United States
(12) Patent Application Publication
(10) Pub. No.: US 2026/0270522 A1
(43) Pub. Date: Sep. 10, 2026

(54) INFORMATION DISPLAY METHOD AND APPARATUS, DEVICE AND COMPUTER-READABLE STORAGE MEDIUM

(71) Applicant: CHENGDU GUANGHEXINHAO TECHNOLOGY CO., LTD., Chengdu, Sichuan Province (CN)

(72) Inventors: Wenjun WANG, Beijing (CN); Hanfei WU, Beijing (CN); Chen CHEN, Beijing (CN); Qianwen LI, Beijing (CN)

(21) Appl. No.: 19/162,902

(22) PCT Filed: Mar. 6, 2024
(86) PCT No.: PCT/CN2024/080214

§ 371 Date: Sep. 5, 2025

(30) Foreign Application Priority Data
Mar. 6, 2023 (CN) 202310205305.5

(51) Int. Cl. H04N 21/482; H04N 21/2187; H04N 21/81

(52) U.S. Cl. CPC H04N 21/4826; H04N 21/2187; H04N 21/8173

(57) ABSTRACT

The present disclosure provides an information display method, a device, and a computer-readable storage medium. The method includes: displaying a live streaming video playing page, the live streaming video playing page including a first object; and displaying object information of the first object on the live streaming video playing page in responding to a preset condition being satisfied.

This application claims the priority of Chinese Patent Application No. 202310205305.5 filed on Mar. 6, 2023, the disclosure of which is hereby incorporated in its entirety as a part of this application.

### TECHNICAL FIELD

Embodiments of the present disclosure relate to an information display method and an apparatus.

### BACKGROUND

Users can watch live videos through applications. In certain scenarios, users wish to obtain information about objects included in a live streaming video playing page while watching live videos.

Currently, to access the information of an object included in a live streaming video playing page, users need to perform specific actions to get the information of the object. However, existing methods for viewing the information is complicated and offers a poor user experience.

### SUMMARY

In order to solve or partially solve the above technical problems, embodiments of the present disclosure provide an information display method and an apparatus.

On the first aspect, the embodiments of the present disclosure provide an information display method, comprising: displaying a live streaming video playing page, the live streaming video playing page comprising a first object; and displaying object information of the first object on the live streaming video playing page in responding to a preset condition being satisfied.

Optionally, the live streaming video playing page comprises a plurality of objects comprising the first object, and the responding to a preset condition being satisfied comprises: responding to the first object being displayed in a preset area of the live streaming video playing page.

Optionally, the responding to the first object being displayed in a preset area of the live streaming video playing page comprises: responding to a content displayed in the preset area being switched from a second object of the plurality of objects to the first object.

Optionally, the preset area is at a center of the live streaming video playing page.

Optionally, the object information of the first object comprises: a name of the first object and a corresponding sequence number of the first object in a first object set, wherein the first object set is an object set associated with the live streaming video playing page, and the first object set comprises the plurality of objects comprising the first object.

Optionally, the responding to a preset condition being satisfied comprises: responding to the first object belonging to a target subset, wherein the target subset is a subset of a second object set, and the second object set is an object set associated with the live streaming video playing page; and the object information of the first object comprises: a name of the target subset, a corresponding sequence number of the target subset in the second object set, and names of a plurality of objects in the target subset.

Optionally, the method further comprises: displaying a detail page of the first object in responding to a trigger operation on the object information of the first object, the detail page of the first object comprising an object transfer control; and performing an object transfer operation to obtain the first object in responding to a trigger operation on the object transfer control.

Optionally, the method further comprises: sending an image comprising the first object to a server, allowing the server to determine the object information of the first object according to the image; and receiving the object information of the first object sent by the server.

On the second aspect, the embodiments of the present disclosure provide an information display apparatus, comprising: a first display unit configured to display a live streaming video playing page, the live streaming video playing page comprising a first object; and a second display unit configured to display object information of the first object on the live streaming video playing page in responding to a preset condition being satisfied.

Optionally, the live streaming video playing page comprises a plurality of objects comprising the first object, and the responding to a preset condition being satisfied comprises: responding to the first object being displayed in a preset area of the live streaming video playing page.

Optionally, the responding to the first object being displayed in a preset area of the live streaming video playing page comprises: responding to a content displayed in the preset area being switched from a second object of the plurality of objects to the first object.

Optionally, the preset area is at a center of the live streaming video playing page.

Optionally, the object information of the first object comprises: a name of the first object and a corresponding sequence number of the first object in a first object set, wherein the first object set is an object set associated with the live streaming video playing page, and the first object set comprises the plurality of objects comprising the first object.

Optionally, the responding to a preset condition being satisfied comprises: responding to the first object belonging to a target subset, wherein the target subset is a subset of a second object set, and the second object set is an object set associated with the live streaming video playing page; and the object information of the first object comprises: a name of the target subset, a corresponding sequence number of the target subset in the second object set, and names of a plurality of objects in the target subset.

Optionally, the apparatus further comprises a third display unit configured to display a detail page of the first object in responding to a trigger operation on the object information of the first object, the detail page of the first object comprising an object transfer control; and an object transfer unit configured to perform an object transfer operation to obtain the first object in responding to a trigger operation on the object transfer control.

Optionally, the apparatus further comprises a sending unit configured to send an image comprising the first object to a server, allowing the server to determine the object information of the first object according to the image; and a receiving unit configured to receive the object information of the first object sent by the server.

On the third aspect, the embodiments of the present disclosure provide a device, comprising a processor and a memory; the processor is configured to execute instructions stored in the memory to enable the device to implement any one method according to the above first aspect.

On the fourth aspect, the embodiments of the present disclosure provide a computer-readable storage medium, comprising instructions, and the instructions, when executed, cause a device to implement any one method according to the above first aspect.

On the fifth aspect, the embodiments of the present disclosure provide a computer diagram product, and the computer diagram product, when run on a computer, causes the computer to implement any one method according to the above first aspect.

### BRIEF DESCRIPTION OF DRAWINGS

To describe the technical solutions in the embodiments of the present disclosure more clearly, the accompanying drawings required to describe the embodiments will be briefly described below. Apparently, the accompanying drawings in the following description are only some embodiments described in the present disclosure. A person of ordinary skill in the art may further derive other accompanying drawings from these embodiments without creative efforts.

FIG. 1 is a flowchart of an information display method according to an embodiment of the present disclosure;

FIG. 2a is a schematic diagram of a live streaming video playing page according to an embodiment of the present disclosure;

FIG. 2b is a schematic diagram of a live streaming video playing page according to an embodiment of the present disclosure; and

FIG. 3 is a schematic diagram of an information display apparatus according to an embodiment of the present disclosure.

### DETAILED DESCRIPTION

In order to provide a better understanding of the solutions of the present disclosure for those skilled in the art, the technical solutions in the embodiments of the present disclosure will be described clearly and completely with reference to the accompanying drawings in the embodiments of the present disclosure. Apparently, the described embodiments are merely some rather than all of the embodiments of the present disclosure. All other embodiments derived from the embodiments in the present disclosure by those of ordinary skill in the art without creative efforts shall fall within the protection scope of the present disclosure.

The inventors of the present disclosure have found through research that currently, when users are watching live videos and wish to view information about objects included in a live streaming video playing page, they must perform corresponding actions. For example, in a live video intended to showcase products, if a user wants to obtain information about the object presented in the live streaming video playing page, the user first need to trigger an appropriate action on the live streaming video playing page to view the list of products being discussed. Then, the user may find the product corresponding to the object included in the current live streaming video playing page from the list, so as to obtain the information about the object. This method requires the user to execute a series of actions to obtain the information about the object, and the actions are cumbersome, which in turn leads to a poor user experience while watching live videos.

To address the above issue, embodiments of the present disclosure provide an information display method and apparatus. The method can be applied to a client and includes: displaying a live streaming video playing page, the live streaming video playing page including a first object; and in responding to a preset condition being satisfied, displaying object information of the first object on the live streaming video playing page. Thus, by utilizing this scheme, users can directly view the object information of the first object through the live streaming video playing page while watching a live video, without needing to perform a series of actions to access the information of the first object. This simplifies user operations and, accordingly, enhances the user experience while watching live videos.

Various embodiments of the present disclosure will be described in detail with reference to the accompanying drawings.

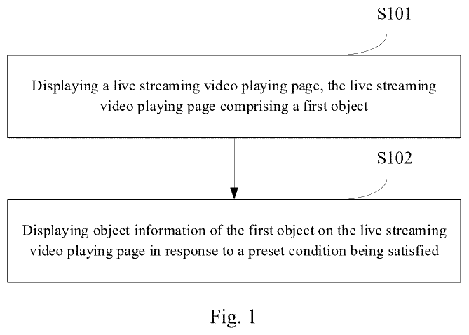

Refer to FIG. 1 which is a flowchart of an information display method according to an embodiment of the present disclosure. In this embodiment, the method can be applied to a client, and the method, for example, may include the following steps: S101-S102.

S101, displaying a live streaming video playing page, the live streaming video playing page including a first object.

In the embodiments of the present disclosure, the live streaming video playing page may be, for example, a live streaming room page or a live preview page of a live streaming room page.

In one example, the live streaming video playing page may be an explanation page for an object. The object may include a physical or a virtual item, such as a product. In one example, the live streaming video playing page is used to explain several objects; in this situation, the first object may be one of the several objects being explained on the live streaming video playing page. In the situation that the object is a product, the first object is a first product.

S102, displaying object information of the first object on the live streaming video playing page in responding to a preset condition being satisfied.

To enable users to obtain the object information of the first object without performing a series of actions, in the embodiments of the present disclosure, the object information of the first object may be displayed in the live streaming video playing page under the condition that the preset condition is met.

In one example, the client may analyze an image comprising the first object to obtain the object information of the first object.

In another example, the client may send an image comprising the first object to a server, allowing the server to determine the object information of the first object according to the image. Correspondingly, after determining the object information of the first object, the server may send the object information of the first object to the client, and after receiving the object information of the first object sent by the server, the client may display the object information of the first object in the live streaming video playing page. In one example, the server may pre-construct corresponding relationships between each object and the object information of the each object, and after receiving the image comprising the first object, the server may analyze the image to determine the first object in the image, then obtain the object information of the first object by means of the pre-constructed corresponding relationship between the first object and the object information of the first object, and send the object information of the first object to the client.

In one scenario, considering that the live streaming video playing page may include multiple objects, for example, the live streaming video playing page includes multiple objects which can be explained in the live streaming video playing page, and a live streamer may sequentially explain the multiple objects. Generally, the object being explained is in a preset area of the live streaming video playing page, which may be, for example, at the center of the live streaming video playing page. Considering that the user may be more interested in the object information of the object being explained by the live streamer, in one example, the responding to a preset condition being satisfied may be the responding to the first object being displayed in a preset area of the live streaming video playing page.

In one example, the first object being displayed in the preset area may be the first object being initially displayed in the preset area, or the display content of the preset area being switched from a second object of the plurality of objects to the first object. In other words, by adopting the scheme of the embodiments of the present disclosure, the object information displayed in the live streaming video playing page can be dynamically switched according to the display content of the preset area. For example, at a first moment, the display content of the preset area is object 1, and then the live streaming video playing page may include the object information of object 1; and at a second moment, the display content of the preset area is switched from object 1 to object 2, and then the object information of object 2 may be displayed in the live streaming video playing page.

In one example, in responding to the first object being displayed in the preset area, the client may display the object information of the first object on the live streaming video playing page, and the object information of the first object may include a name of the first object and a sequence number of the first object in a first object set. Here, the first object set is a set of objects associated with the live streaming video playing page, the first object set may include a plurality of objects, and the first object is one of the plurality of objects. The objects associated with the live streaming video playing page mentioned here may be the objects being explained on the live streaming video playing page. In one example, the plurality of objects shown in the live streaming video playing page may be part of the objects in the first object set or all the objects in the first object set, which is not limited by the embodiments of the present disclosure. Therefore, with this scheme, the user can directly view the object information of the first object on the live streaming video playing page without performing a series of actions, thus improving the object information acquisition efficiency.

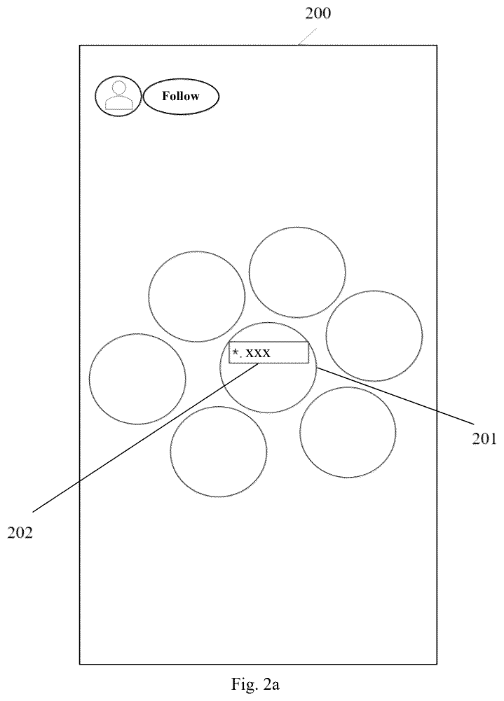

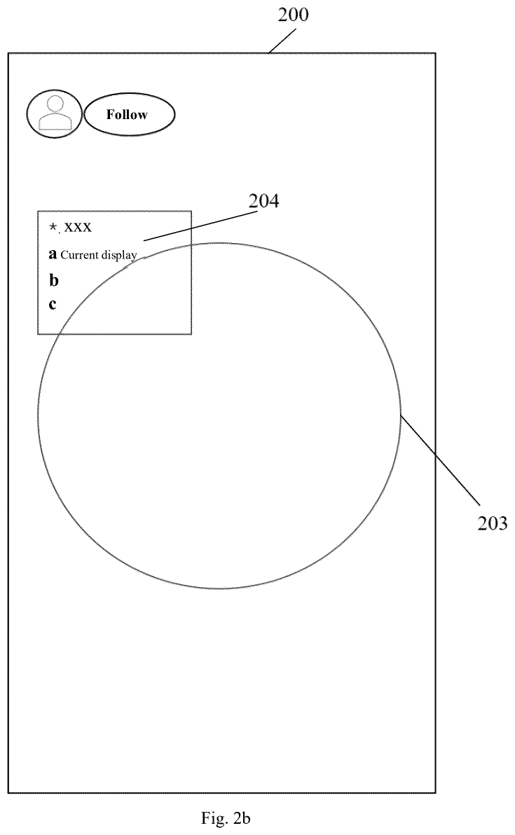

Refer to FIG. 2a which is a schematic diagram of a live streaming video playing page according to an embodiment of the present disclosure. As shown in FIG. 2a, the live streaming video playing page 200 includes a plurality of objects. In FIG. 2a, a circle represents an object, and an object 201 is located at the center of the live streaming video playing page; the live streaming video playing page further includes object information 202 of the object 201, and the object information 202 includes an object name “XXX” of the object 201 and a corresponding sequence number “*” of the object 201 in a first object set corresponding to the live streaming video playing page.

In one example, to allow users to perform more interactions related to the first object, the object information of the first object may also support interaction. Users may trigger an operation on the object information of the first object, for instance, by clicking on the object information of the first object. Accordingly, the client may display a detail page of the first object in responding to a trigger operation on the object information of the first object. The detail page of the first object may include specifics about the first object, such as a detailed description. Additionally, the detail page of the first object may also include an object transfer control, and users may trigger operations on the object transfer control, like clicking on the object transfer control. Accordingly, the client may perform an object transfer operation in responding to a trigger operation on the object transfer control, so as to obtain (e.g., purchase) the first object. In a specific example, the client may display an object transfer page in responding to a trigger operation on the object transfer control, and users can trigger the object transfer operation on the object transfer page. Consequently, the client may obtain the first object in responding to the object transfer operation.

In another scenario, the live streaming video playing page may be associated with an object set, for example, a product being explained on the live streaming video playing page may be a set that includes multiple individual items. In this case, the object set may be displayed as a whole on the live streaming video playing page, or the individual items within the object set may be displayed separately. For instance, for a set that includes multiple individual items, the live streamer may explain the set as a whole or explain the individual items one by one. When the live streamer is explaining an individual item from the set, users may want to obtain information about the set to which the individual item belongs. In this context, as an example, the preset condition may be that the first object belongs to a target subset. Here, the target subset may be a subset of a second object set, and the second object set is similar to the first object set, both of which may be object sets associated with the live streaming video playing page. For instance, the second object set may be a set of multiple objects being explained on the live streaming video playing page. In one example, the target subset may correspond to the aforementioned set including multiple individual items; correspondingly, the first object is one of the individual items. In this case, the object information of the first object displayed by the client may be the information of the aforementioned target subset.

In one example, the information of the target subset may include: a name of the target subset, a corresponding sequence number of the target subset in the second object set, and names of a plurality of objects in the target subset. Thus, with this scheme, users can directly view the information of the target subset on the live streaming video playing page without performing a series of actions, thus improving the information acquisition efficiency.

In one example, the information of the target subset may also include first indication information, which is used to indicate that the content currently displayed on the live streaming video playing page is the first object. For instance, the client may display the names of the plurality of objects included in the target subset in a list format, and the name of one object corresponds to an entry in the list. In a display area corresponding to the entry for the first object, the first object may also be shown. In this manner, users can not only quickly obtain information about the target subset, but also quickly identify that the object currently displayed on the live streaming video playing page is the first object.

In one example, the name of the first object may be displayed at the top among the names of the plurality of objects. This method allows users to quickly identify that the object currently displayed on the live streaming video playing page is the first object.

Referring to FIG. 2b, FIG. 2b is a schematic diagram of another live streaming video playing page according to an embodiment of the present disclosure. As shown in FIG. 2b, the live streaming video playing page 200 includes an object 203 (represented by a circle in FIG. 2b), which belongs to a target subset. The live streaming video playing page also includes a name of the target subset “XXX”, a corresponding sequence number “*” of the target subset in a second object set corresponding to the live streaming video playing page, and names of a plurality of objects included in the target subset. In this example, the target subset includes three objects, named a, b, and c, where the name of the first object is a, displayed at the top among the names of the three objects. Additionally, the live streaming video playing page includes first indication information 204 which indicates the first object as the currently displayed object on the live streaming video playing page.

In one example, to allow users to perform more interactions related to the target subset, the information of the target subset may also support interaction. Users may trigger operations on the information of the target subset, for instance, by clicking on the information of the target subset. Accordingly, the client may display a detail page of the target subset in responding to a trigger operation on the information of the target subset. The detail page of the target subset may include specifics about the target subset, such as a detailed description. Additionally, the detail page of the target subset may also include an object transfer control, and users may trigger an operation on the object transfer control, like clicking on the object transfer control. Accordingly, the client may perform an object transfer operation in responding to a trigger operation on the object transfer control, so as to obtain the target subset. In a specific example, the client may display an object transfer page in responding to a trigger operation on the object transfer control, and users can perform the object transfer operation on the object transfer page. Consequently, the client may obtain the target subset in responding to the object transfer operation.

Based on the method provided in the above embodiment, an embodiment of the present disclosure provides an apparatus, which will be introduced below with reference to the attached drawings.

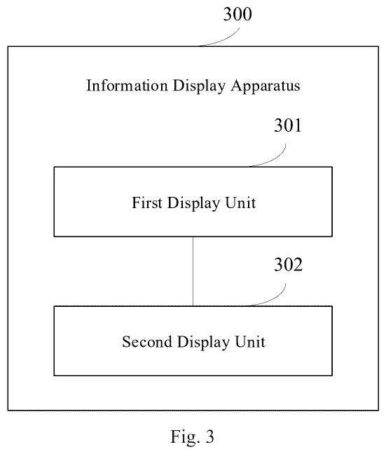

Refer to FIG. 3 which is a schematic diagram of an information display apparatus according to an embodiment of the present disclosure. For example, the apparatus 300 may specifically include a first display unit 301 and a second display unit 302.

The first display unit 301 is configured to display a live streaming video playing page, the live streaming video playing page including a first object.

The second display unit 302 is configured to, in responding to a preset condition being satisfied, display object information of the first object on the live streaming video playing page.

Alternatively, the live streaming video playing page includes a plurality of objects, and the plurality of objects include the first object. The responding to a preset condition being satisfied includes: responding to the first object being displayed in a preset area of the live streaming video playing page.

Alternatively, the responding to the first object being displayed in a preset area of the live streaming video playing page includes: the responding to the content displayed in the preset area being switched from a second object among the plurality of objects to the first object.

Alternatively, the preset area is located at the center of the live streaming video playing page.

Alternatively, the object information of the first object includes: a name of the first object and a corresponding sequence number of the first object in a first object set, the first object set being an object set associated with the live streaming video playing page, the first object set including a plurality of objects, and the plurality of objects containing the first object.

Alternatively, the responding to a preset condition being satisfied includes: the responding to the first object belonging to a target subset, the target subset being a subset of a second object set, and the second object set being an object set associated with the live streaming video playing page.

The object information of the first object includes: a name of the target subset, a corresponding sequence number of the target subset in the second object set, and names of a plurality of objects in the target subset.

Alternatively, the apparatus further includes: a third display unit configured to display a detail page of the first object in responding to a trigger operation on the object information of the first object, the detail page of the first object including an object transfer control; and an object transfer unit configured to perform an object transfer operation in responding to a trigger operation on the object transfer control, so as to obtain the first object.

Alternatively, the apparatus further includes: a sending unit configured to send an image containing the first object to a server, allowing the server to determine the object information of the first object according to the image; and a receiving unit configured to receive the object information of the first object sent by the server.

As the apparatus 300 is an apparatus corresponding to the method provided by the above method embodiment, the specific implementation of each unit of the apparatus 300 is based on the same concept as the above method embodiment. Therefore, for the specific implementation of each unit of the apparatus 300, reference can be made to the relevant descriptions of the above method embodiment, which will not be repeated here.

An embodiment of the present disclosure also provides a device, which includes a processor and a memory, and the processor is used for executing instructions stored in the memory to enable the device to implement the information display method described in any one of the above method embodiments.

An embodiment of the present disclosure also provides a computer-readable storage medium, which includes instructions that instruct a device to implement the information display method described in any one of the above method embodiments.

An embodiment of the present disclosure further provides a computer program product, and when the computer program product is run on a computer, the computer implements the information display method described in any one of the above method embodiments.

Those skilled in the art may easily conceive of other embodiments of the present disclosure after considering the specification and practicing the invention disclosed herein. The present disclosure is intended to cover any variations, purposes or applicable changes of the present disclosure. Such variations, purposes or applicable changes follow the general principle of the present disclosure and include common knowledge or conventional technical means in the technical field which is not disclosed in the present disclosure. The specification and embodiments are merely considered as illustrative, and the real scope and spirit of the present disclosure are pointed out by the appended claims.

It should be noted that, the present disclosure is not limited to the precise structures that have been described above and shown in the accompanying drawings, and can be modified and changed in many ways without departing from the scope of the present disclosure. The scope of the present disclosure is defined by the appended claims.

The foregoing are merely descriptions of the preferred embodiments of the present disclosure and are not intended to limit the present disclosure. Any modification, equivalent replacement, improvement and the like made within the spirit and principle of the present disclosure shall be included within the protection scope of the present disclosure.

1. An information display method, comprising:
displaying a live streaming video playing page, the live streaming video playing page comprising a first object; and
displaying object information of the first object on the live streaming video playing page in responding to a preset condition being satisfied.

2. The method according to claim 1, wherein the live streaming video playing page comprises a plurality of objects comprising the first object, and the responding to a preset condition being satisfied comprises:
responding to the first object being displayed in a preset area of the live streaming video playing page.

3. The method according to claim 2, wherein the responding to the first object being displayed in a preset area of the live streaming video playing page comprises:
responding to a content displayed in the preset area being switched from a second object of the plurality of objects to the first object.

4. The method according to claim 2, wherein the preset area is at a center of the live streaming video playing page.

5. The method according to claim 2, wherein the object information of the first object comprises:
a name of the first object and a corresponding sequence number of the first object in a first object set, wherein the first object set is an object set associated with the live streaming video playing page, and the first object set comprises the plurality of objects comprising the first object.

6. The method according to claim 1, wherein the responding to a preset condition being satisfied comprises:
responding to the first object belonging to a target subset, wherein the target subset is a subset of an object set, and the object set is associated with the live streaming video playing page; and
the object information of the first object comprises:
a name of the target subset, a corresponding sequence number of the target subset in the object set, and names of a plurality of objects in the target subset.

7. The method according to claim 2, further comprising:
displaying a detail page of the first object in responding to a trigger operation on the object information of the first object, the detail page of the first object comprising an object transfer control; and
performing an object transfer operation to obtain the first object in responding to a trigger operation on the object transfer control.

8. The method according to claim 1, further comprising:
sending an image comprising the first object to a server, allowing the server to determine the object information of the first object according to the image; and
receiving the object information of the first object sent by the server.

9. (canceled)

10. A device, comprising a processor and a memory, wherein the processor is configured to execute instructions stored in the memory to enable the device to implement an information display method comprising:
displaying a live streaming video playing page, the live streaming video playing page comprising a first object; and
displaying object information of the first object on the live streaming video playing page in responding to a preset condition being satisfied.

11. A computer-readable storage medium, comprising instructions, wherein the instructions, when executed, cause a device to implement an information display method comprising:
displaying a live streaming video playing page, the live streaming video playing page comprising a first object; and
displaying object information of the first object on the live streaming video playing page in responding to a preset condition being satisfied.

12. The device according to claim 10, wherein the live streaming video playing page comprises a plurality of objects comprising the first object, and
the displaying object information of the first object on the live streaming video playing page in responding to a preset condition being satisfied comprises:
displaying the object information of the first object on the live streaming video playing page in responding to the first object being displayed in a preset area of the live streaming video playing page.

13. The device according to claim 12, wherein the displaying object information of the first object on the live streaming video playing page in responding to the first object being displayed in a preset area of the live streaming video playing page comprises:
displaying the object information of the first object on the live streaming video playing page in responding to a content displayed in the preset area being switched from a object of the plurality of objects to the first object.

14. The device according to claim 12, wherein the preset area is at a center of the live streaming video playing page.

15. The device according to claim 12, wherein the object information of the first object comprises:
a name of the first object and a corresponding sequence number of the first object in a first object set, wherein the first object set is an object set associated with the live streaming video playing page, and the first object set comprises the plurality of objects comprising the first object.

16. The device according to claim 10, wherein the displaying object information of the first object on the live streaming video playing page in responding to a preset condition being satisfied comprises:
displaying object information of the first object on the live streaming video playing page in responding to the first object belonging to a target subset, wherein the target subset is a subset of a first object set, and the first object set is an object set associated with the live streaming video playing page; and
the object information of the first object comprises:
a name of the target subset, a corresponding sequence number of the target subset in the first object set, and names of a plurality of objects in the target subset.

17. The device according to claim 12, wherein the information display method further comprises:
displaying a detail page of the first object in responding to a trigger operation on the object information of the first object, the detail page of the first object comprising an object transfer control; and
performing an object transfer operation to obtain the first object in responding to a trigger operation on the object transfer control.

18. The device according to claim 10, wherein the information display method further comprises:
sending an image comprising the first object to a server, allowing the server to determine the object information of the first object according to the image; and
receiving the object information of the first object sent by the server.
